(19) United States
(12) Patent Application Publication
(10) Pub. No.: US 2008/0109748 A1
(43) Pub. Date: May 8, 2008

(54) Browsing System and Method Thereof

(76) Inventor: Lai-Chen Lai, Yonghe City (TW)

Correspondence Address: LAW OFFICES OF LAI AND ASSOCIATES, P.C., 5800 RANCHESTER STE 200, HOUSTON, TX, 77036, US

(21) Appl. No.: 11/556,065

(22) Filed: Nov. 2, 2006

(51) Int. Cl. G06F 3/048

(52) U.S. Cl. 715/781; 715/788

(57) ABSTRACT

A browsing system and method thereof are applied in an electronic apparatus to browse a document data. The scope of the document data is greater than a screen of the electronic apparatus. The browsing system at least comprises a detection unit and a display processing unit. The detection unit is used to detect a displacement and a displacement direction generated by the electrical apparatus while moving. The display processing unit is used to enable the electronic apparatus to display a corresponding screen of the document data based on the displacement and the displacement direction. The browsing system can be activated and the zoom-in or the zoom-out of the document data can be controlled through an operation interface of the electronic apparatus.

### FIELD OF THE INVENTION

The present invention relates to a browsing system and method thereof, and more particularly to use an infrared ray sensor to sense a displacement of an electronic apparatus, thereby controlling a screen displayed by the electronic apparatus.

### BACKGROUND OF THE INVENTION

Currently, electronic apparatuses for use in browsing document data are very popular. Computers, personal digital assistants (PDA), mobile phones and graphic browsers are used to browse document data like pictures, scripts files and maps. However, the size of display of the electronic apparatuses is restricted by volume and cost considerations, so the document data may not be displayed completely.

Referring to FIG. 1, a schematic diagram illustrates an electronic apparatus for browsing documents by using a scrolling way in prior arts. The electronic apparatus comprises a display 11, an up-shift key 12, a down-shift key 13, a left-shift key 14, a right-shift key 15, a zoom-in key 16, and a zoom-out key 17. A user uses the display 11 to browse a document data. When the scope of the document data is greater than the screen of the display 11, the user could operate the up-shift key 12, the down-shift key 13, the right-shift key 15, and the left-shift key 14 to move the screen of the display, and use the zoom-in key 16 and the zoom-out key 17 to modify the screen resolution displayed by the display.

Referring to FIG. 2, a schematic diagram illustrates an electronic apparatus for browsing documents by using a touch way in prior arts. The electronic apparatus has a touch display unit 21. The touch display unit 21 has display and sensing functions. The touch display unit 21 uses the display function to display a document data. When the scope of the document data is grater than the screen of the touch display unit 21, the sensing function of the touch display unit 21 provides the user to perform a touch action. A dashed line graphic representation 22 as shown in the figure is a first position. Next, a finger touches the touch display unit 21 and moves toward an arrow 23. The touch display unit 21 displays a display graphic representation 24 at a second position based on the displacement distance and the movement direction of the arrow 22. The user directly drags the document data to achieve the goal of browsing documents.

The scrolling way is used to perform a control action that is too complex and inconvenient for the user. The user may not be satisfied. Moreover, the touch way which controls the screen belongs to an intuitive operating method. However, the sensing interface easily suffers a lot of wear and tear when times generated by finger touch are increased. The sensing function may not be kept good.

The inventor of the present invention based on years of experience from conducting extensive research and experiments invents a browsing system and method thereof, such as using a detection unit with an infrared ray sensor to detect the moving of an electronic apparatus, thereby avoiding the complex operating procedure. An intuitive operational functionality is therefore provided. The operation area is also saved and damage may not easily occur.

### SUMMARY OF THE INVENTION

A primary object of the present invention is to provide a browsing system and method thereof that are applied in an electronic apparatus to browse a document data. The scope of the document data is greater than a screen of the electronic apparatus. The browsing system comprises a detection unit and a display processing unit. An intuitive operational functionality is then provided for the electronic apparatus to simplify the operating procedure.

The browsing system is applied in the electronic apparatus according to the present invention. The browsing system comprises the detection unit and the display processing unit. The electronic apparatus is one selected from a personal digital assistant (PDA) which includes a display and an operation interface, a mobile phone or a graphic browser. The detection unit is for detecting a displacement and a displacement direction generated by the electronic apparatus while moving. The display processing unit then enables the electronic apparatus to display a corresponding screen of the document data based on the displacement and the displacement direction. Moreover, the electronic apparatus uses the display to display the screen of the document data. The operation interface is used to activate the browsing system. Furthermore, the display processing unit is controlled through the operation interface. The display processing unit could zoom in or out the document data. In addition, the document data is preferably a picture file or a script file. The operating procedure of the electronic apparatus is then simplified to increase convenience.

Other features and advantages of the present invention and variations thereof will become apparent from the following description, drawings, and claims.

### BRIEF DESCRIPTION OF THE DRAWINGS

FIG. 1 is a schematic diagram illustrating an electronic apparatus for browsing document data by using a scrolling way in prior arts;

FIG. 2 is a schematic diagram illustrating an electronic apparatus for browsing document data by using a touch way in prior arts;

FIG. 3 is a block diagram illustrating a browsing system of the present invention;

FIG. 4 is a schematic diagram illustrating an electronic apparatus with a browsing system of the present invention;

FIG. 5 is a flowchart illustrating a detection unit for detecting the outside movement of the present invention;

FIG. 6 is a flowchart illustrating an operating method of the present invention;

FIG. 7 and FIG. 8 are schematic diagrams illustrating an operating method of the present invention; and

FIG. 9 is a flowchart illustrating a browsing method of the present invention.

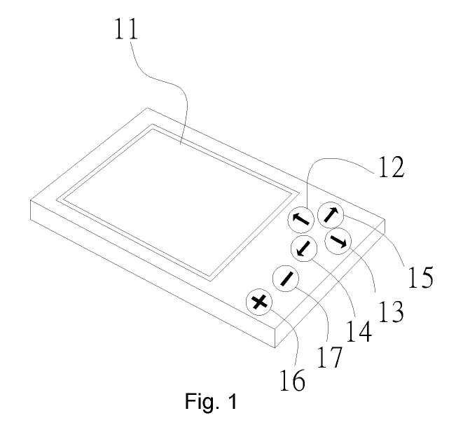

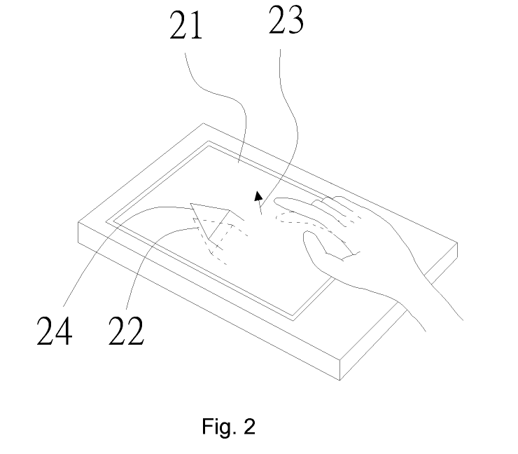

### DETAILED DESCRIPTION OF THE PREFERRED EMBODIMENTS

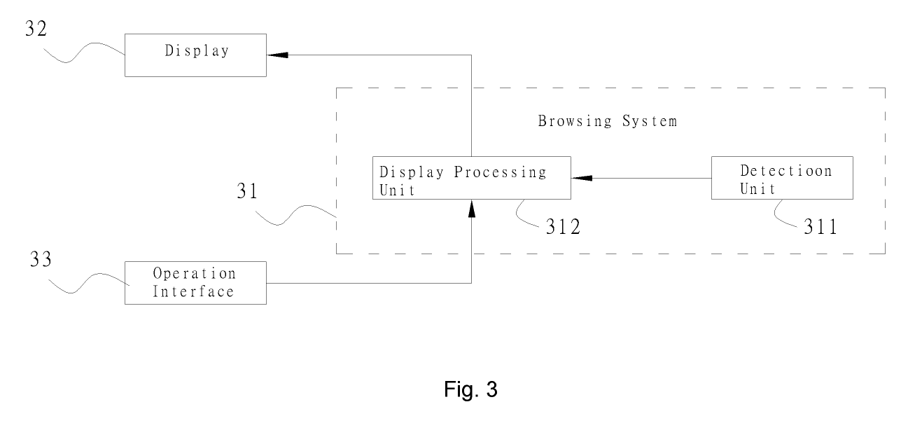

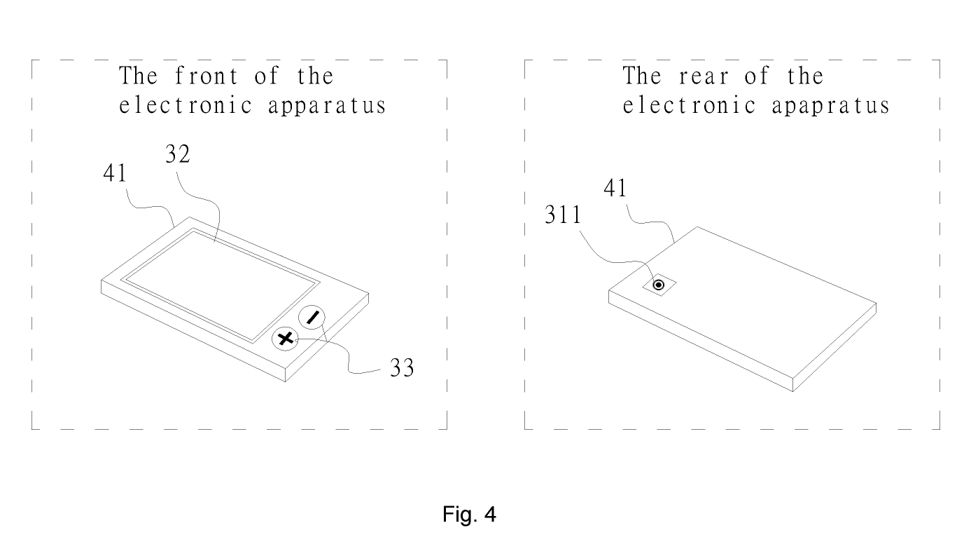

Referring to FIG. 3 and FIG. 4, FIG. 3 is a block diagram illustrating a browsing system of the present invention. FIG. 4 is a schematic diagram illustrating an electronic apparatus with a browsing system of the present invention. As shown in FIG. 3, the browsing system 31 disclosed by the present invention is applied in the electronic apparatus. The browsing system 31 comprises a detection unit 311 and a display processing unit 312. The electronic apparatus is an apparatus which has a display 32 and an operation interface 33, such as PDA, a mobile phone or a graphic browser.

The detection unit 311 sends an infrared ray to the outside surface in order to capture an image which is transmitted back from the outside surface. A target area is then set in the image. After a sampling time, next image is captured and compared with the target area to find out an area that matches the target area. A displacement and a displacement direction generated by movement of the electronic apparatus are detected based on the relationship between the target area and the matching area. As shown in FIG. 4, the detection unit 311 is disposed to the rear of an electronic apparatus 41, and is preferably an infrared ray sensor. The display processing unit 312 controls the electronic apparatus to display a corresponding screen of the document data based on the displacement and the displacement detected by the detection unit 311. In addition, the display processing unit 312 also controls the zoom-in or the zoom-out of the document data.

The display 32 of the electronic apparatus displays the corresponding screen of the document data through the control of the display processing unit 312. As shown in FIG. 4, the display 32 is disposed to the front of the electronic apparatus 41 to allow an operation end to watch when the detection unit 311 detects. An operation interface 33 of the electronic apparatus 41 does not only provide the operation end to activate the browsing system 31, but also provides the operation end to control the zoom-in or zoom-out. The display processing unit 312 could zoom in or out the document data in order to modify the screen resolution displayed by the display 32.

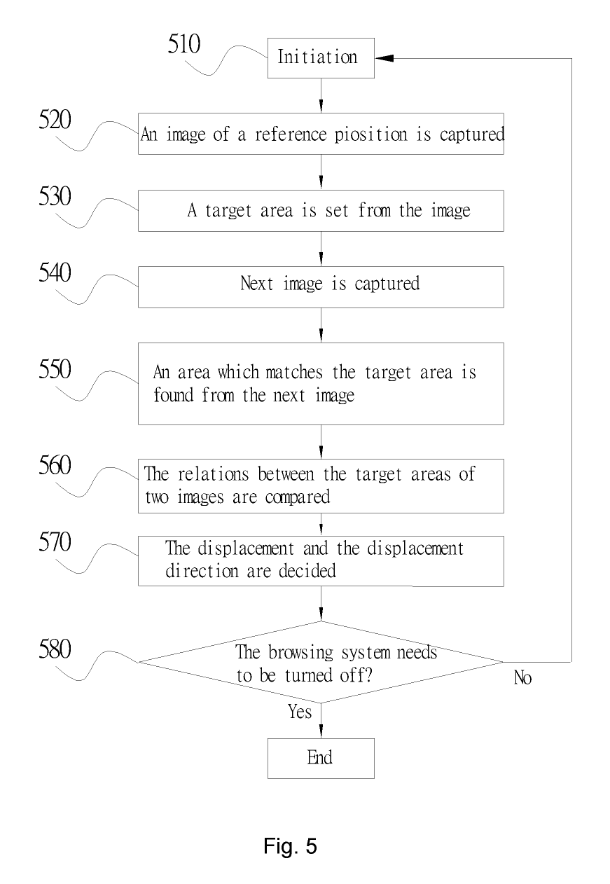

Referring to FIG. 5, a flowchart illustrates the detection unit 311 for detecting the outside movement of the present invention. Firstly, the detection unit is initiated (510). The detection unit 311 decides a reference position by receiving an activating signal. An image of the reference position is captured (520). A target area is set from the image (530). A next image is captured after a predetermined sampling time (540). An area which matches the target area is found from the next image (550). The relations between the target areas of two images are compared (560) to decide the displacement and the displacement direction (570). In addition, the operation end decides whether or not the browsing system needs to be shut down (580). If yes, the detection unit finishes the detection. If not, returns to the aforementioned steps for circulating to achieve the goal of using the detection unit to detect the displacement and the displacement direction generated by movement of the electronic apparatus.

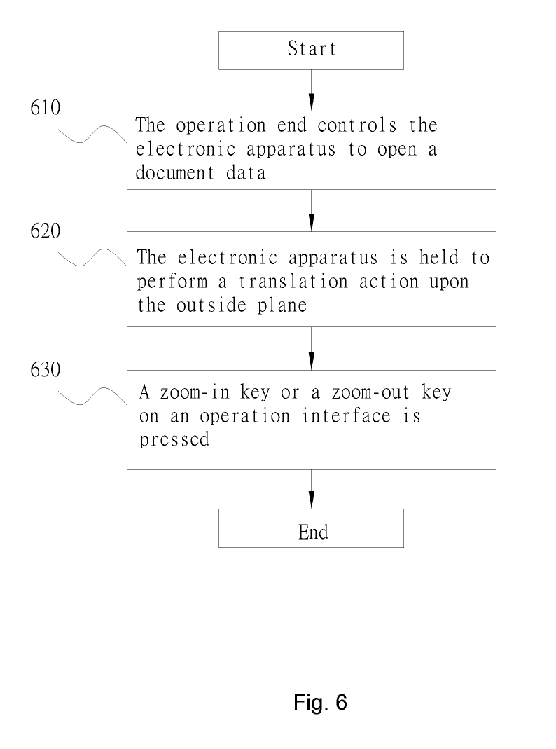

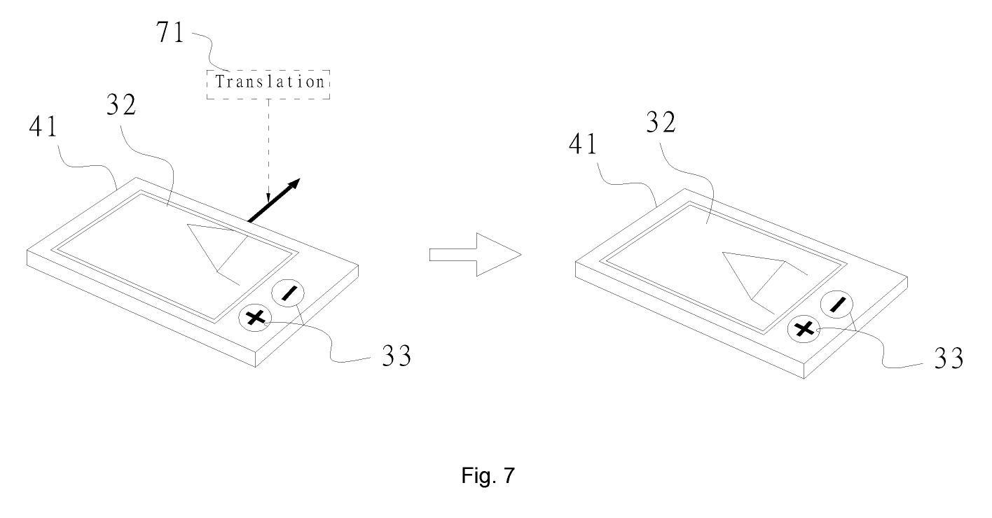

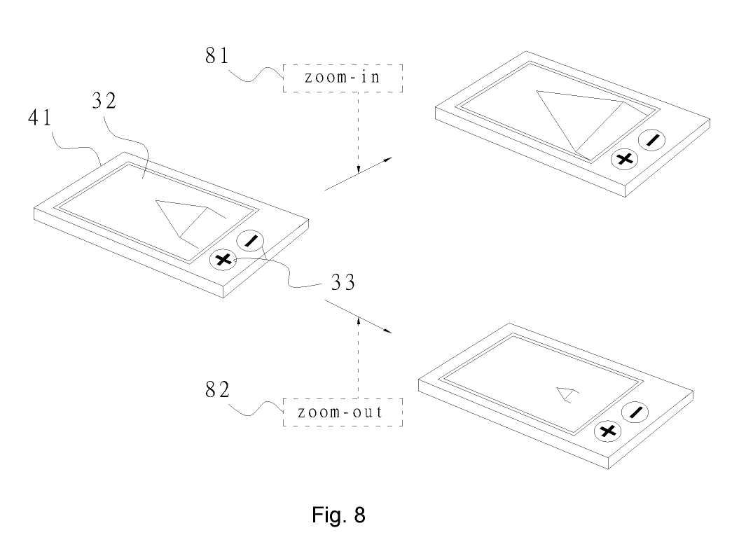

In accordance with the browsing system disclosed by the present invention, referring to FIG. 6 to FIG. 8, FIG. 6 is a flowchart illustrating an operating method of the present invention. FIG. 7 and FIG. 8 are schematic diagrams illustrate an operating method. Firstly, the operation end controls the electronic apparatus to open a document data (610). Because the scope of the document data is greater than the screen displayed by the electronic apparatus, the electronic apparatus only displays a portion of the screen of the document data. As shown in FIG. 7, the operation end holds the electronic apparatus to perform a translation action 71 upon the outside plane (620). The electronic apparatus then displays a corresponding screen of the document data to control the display screen by moving the electronic apparatus. Lastly, a zoom-in key or a zoom-out key on an operation interface is pressed (630). As shown in FIG. 8, the electronic apparatus is moved to a position for browsing. The screen displayed by the electronic apparatus 41 is zoomed in 81 or out 82 by the operation interface 33.

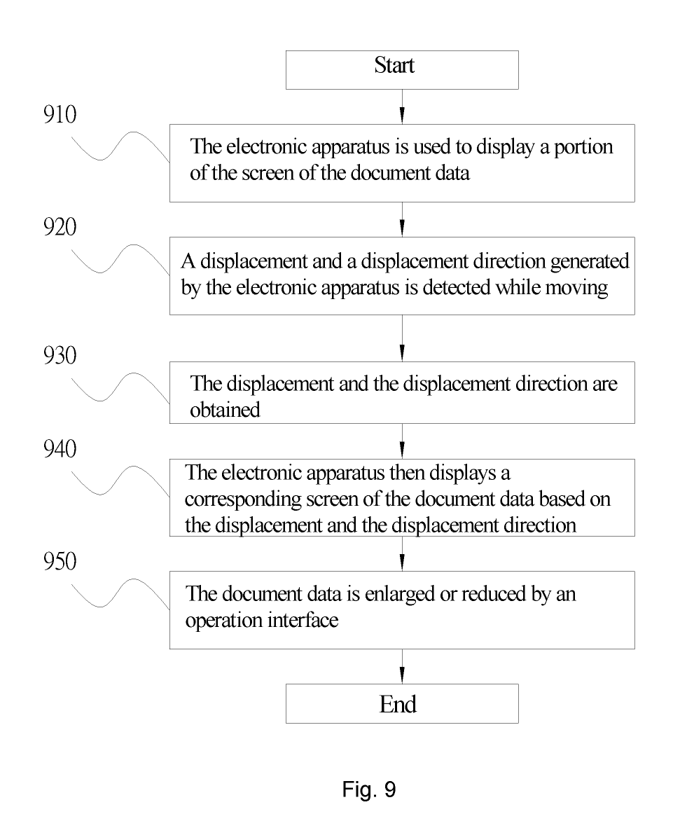

Referring to FIG. 9, a flowchart illustrates a browsing method of the present invention. The method is used in an electronic apparatus to browse a document data. The scope of the document data is greater than the screen displayed by the electronic apparatus. The method includes the following steps:

Step 910: The electronic apparatus is used to display a portion of the screen of the document data.

Step 920: A displacement and a displacement direction generated by movement of the electronic apparatus is detected.

Step 930: The displacement and the displacement direction are obtained.

Step 940: The electronic apparatus then displays a corresponding screen of the document data based on the displacement and the displacement direction.

Step 950: The document data is zoomed in or out by an operation interface.

One of a PDA, a mobile phone or graphic browser is selected to be the electronic apparatus. A display is disposed in the electronic apparatus for displaying the document data. The document data is preferably a pattern file or a script file. In addition, an infrared ray sensor is used to detect the displacement and the displacement direction.

Although the features and advantages of the embodiments according to the preferred invention are disclosed, it is not limited to the embodiments described above, but encompasses any and all modifications and changes within the spirit and scope of the following claims.

What is claimed is:

1. A browsing system, applicable for an electronic apparatus for browsing a document data, the scope of said document data being greater than a screen of said electronic apparatus, and said browsing system comprising:
a detection unit for detecting a displacement and a displacement direction generated by said electronic apparatus while moving; and
a display processing unit for enabling said electronic apparatus to display a corresponding screen of said document data based on said displacement and said displacement direction.

2. The browsing system of claim 1, wherein said electronic apparatus is one of a personal digital assistant (PDA), a mobile phone or a graphic browser.

3. The browsing system of claim 1, wherein said electronic apparatus comprises a display for displaying said document data.

4. The browsing system of claim 1, wherein said electronic apparatus comprises an operation interface.

5. The browsing system of claim 4, wherein said operation interface is for controlling the zoom-in of said document data.

6. The browsing system of claim 4, wherein said operation interface is for controlling the zoom-out of said document data.

7. The browsing system of claim 1, wherein said detection unit is an infrared ray sensor.

8. The browsing system of claim 1, wherein said document data is a picture file or a script file.

9. A browsing method for browsing a document data through an electronic apparatus, the scope of said document data being greater than a screen of said electronic apparatus, and said browsing method comprising:
displaying a portion of said document data on said screen of said electronic apparatus;
detecting a displacement and a displacement direction generated by said electronic apparatus moving; and
enabling said screen of said electronic apparatus to display a corresponding screen of said document data based on said displacement and said displacement direction.

10. The browsing method of claim 9, further comprising the step of using one of a PDA, a mobile phone or a graphic browser to be said electronic apparatus.

11. The browsing method of claim 9, further comprising the step of disposing a display to said electronic apparatus for displaying said document data.

12. The browsing method of claim 9, further comprising the step of providing an infrared ray sensor to detect said displacement and said displacement direction.

13. The browsing method of claim 9, further comprising the step of providing a picture file or a script file to be said document data.

14. The browsing method of claim 9, further comprising the step of providing an operation interface.

15. The browsing method of claim 14, further comprising the step of providing the zoom-in of said document data to be said operation interface.

16. The browsing method of claim 14, further comprising the step of providing the zoom-out of said document data to be said operation interface.
